(19) United States
(12) Patent Application Publication
(10) Pub. No.: US 2012/0284067 A1
(43) Pub. Date: Nov. 8, 2012

(54) REVENUE-BASED IMPACT ANALYSIS USING MULTIDIMENSIONAL MODELS OF SOFTWARE OFFERINGS

(75) Inventors: Jerome Labat, San Carlos, CA (US); Ramkumar Venkataraman, Foster City, CA (US); John Eugene Edward, Fremont, CA (US); Ramachandran Varadharajan, Fremont, CA (US)

(73) Assignee: INTUIT INC., Mountain View, CA (US)

(21) Appl. No.: 13/100,156

(22) Filed: May 3, 2011

(51) Int. Cl. G06Q 10/00

(52) U.S. Cl. 705/7.11

(57) ABSTRACT

The disclosed embodiments provide a system that facilitates the maintenance and execution of a software offering. During operation, the system obtains a total revenue associated with the software offering and a set of weight vectors associated with a multidimensional model of the software offering, wherein each of the weight vectors comprises a set of revenue weights. Next, the system calculates a set of component revenues associated with a set of service components and a set of resources used by the software offering by applying the total revenue and the weight vectors to the multidimensional model. Finally, the system uses the component revenues to facilitate management of the software offering.

### RELATED APPLICATION

The subject matter of this application is related to the subject matter in a co-pending non-provisional application by inventors Jerome Labat, Ramachandran Varadharajan, Wilson W. Lau, and Thomas C. Bishop, entitled “Multidimensional Modeling of Software Offerings,” having Ser. No. 13/031,950, and filed on 22 Feb. 2011 (Attorney Docket No. INTU-115591).

The subject matter of this application is also related to the subject matter in a co-pending non-provisional application by inventors Jerome Labat, Ramachandran Varadharajan, Wilson W. Lau, and Thomas C. Bishop, entitled “Automatic Provisioning of Resources to Software Offerings,” having Ser. No. 13/031,968, and filed on 22 Feb. 2011 (Attorney Docket No. INTU-115592).

### BACKGROUND

### RELATED ART

The present embodiments relate to techniques for managing software offerings. More specifically, the present embodiments relate to revenue-based impact analysis of the software offerings using multidimensional models of the software offerings.

Recent computing trends have shifted the processing and consumption of data and services to cloud computing systems. Such cloud computing systems allow software providers to deploy, execute, and manage software offerings on shared infrastructure resources such as servers, network equipment, platform-virtualization software, and/or data-center space. Furthermore, such resources may be dynamically provisioned and/or scaled, thus enabling consumption of the resources as services.

For example, a cloud computing provider may provide virtualized storage, network, and/or computing resources to multiple cloud computing customers. The cloud computing customers may deploy software offerings on the virtualized resources and pay the cloud computing provider only for resources consumed by the software offerings. As a result, the cloud computing customers may avoid capital expenditures associated with purchasing, setting up, and/or managing the underlying hardware and software. Furthermore, the centralization and sharing of infrastructure resources may improve the resources' utilization rates and management overhead.

Hence, the deployment, execution, and management of software offerings may be facilitated by mechanisms for dynamically allocating, configuring, and monitoring infrastructure resources used by the software offerings.

### SUMMARY

The disclosed embodiments provide a system that facilitates the maintenance and execution of a software offering. During operation, the system obtains a total revenue associated with the software offering and a set of weight vectors associated with a multidimensional model of the software offering, wherein each of the weight vectors comprises a set of revenue weights. Next, the system calculates a set of component revenues associated with a set of service components and a set of resources used by the software offering by applying the total revenue and the weight vectors to the multidimensional model. Finally, the system uses the component revenues to facilitate management of the software offering.

In some embodiments, calculating the set of component revenues associated with the service components and the resources used by the software offering involves using the total revenue as a component revenue for a root node of the multidimensional model, and calculating a set of child component revenues for each set of child nodes in the multidimensional model by applying a weight vector associated with the set of child nodes to a parent component revenue for a parent node of the child nodes.

In some embodiments, calculating the set of child component revenues involves at least one of splitting the parent component revenue into the set of child component revenues, and merging a set of parent component revenues from two or more parent nodes into a child component revenue for a child node connected to the parent nodes.

In some embodiments, a weight vector comprises identical revenue weights if the weight vector is associated with a set of identical service components or resources, and a weight vector comprises dissimilar revenue weights if the weight vector is associated with a set of non-identical service components or resources.

In some embodiments, using the component revenues to facilitate management of the software offering involves at least one of:
(i) using the component revenues to determine a recovery sequence for the software offering;
(ii) modifying use of the service components and the resources by the software offering based on the component revenues; and
(iii) calculating a cost of an outage associated with the software offering based on the component revenues.

In some embodiments, the recovery sequence corresponds to a decreasing sequence of the component revenues.

In some embodiments, modifying use of the service components and the resources by the software offering based on the component revenues involves at least one of:
(i) allocating spending on the service components and the resources based on the component revenues;
(ii) prioritizing service requests associated with the service components and the resources; and
(iii) reprovisioning resources to the software offering based on the component revenues.

In some embodiments, calculating the cost of the outage associated with the software offering based on the component revenues involves:
(i) obtaining an outage period for the outage;
(ii) determining a fraction of total transactions for the software offering represented by a number of missed transactions associated with the outage; and
(iii) multiplying one or more of the component revenues associated with the outage by the fraction of total transactions.

### BRIEF DESCRIPTION OF THE FIGURES

FIG. 1 shows a schematic of a system in accordance with an embodiment.

FIG. 2 shows a system for performing revenue-based impact analysis of a software offering in accordance with an embodiment.

FIG. 3 shows an exemplary set of component revenues for a set of nodes in a multidimensional model in accordance with an embodiment.

FIG. 4 shows a flowchart illustrating the process of facilitating the maintenance and execution of a software offering in accordance with an embodiment.

FIG. 5 shows a flowchart illustrating the process of calculating a set of component revenues associated with service components and resources used by a software offering in accordance with an embodiment.

FIG. 6 shows a flowchart illustrating the process of calculating the cost of an outage associated with a software offering in accordance with an embodiment.

FIG. 7 shows a computer system in accordance with an embodiment.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The disclosed embodiments provide a method and system for facilitating the maintenance and execution of a software offering. The software offering may correspond to an application that is deployed on one or more servers and accessed over a network connection. For example, the software offering may provide a web application, distributed application, and/or web service to users of the software offering.

More specifically, the disclosed embodiments provide a method and system for revenue-based impact analysis of the software offering using a multidimensional model of the software offering. The multidimensional model may include a set of service components in the software offering, a set of resources used by the software offering, and a set of dependencies among the service components and/or resources. The multidimensional model may thus facilitate the deployment, execution, and maintenance of the software offering.

To perform the revenue-based impact analysis, a total revenue associated with the software offering and a set of weight vectors associated with the multidimensional model may be obtained. A set of component revenues associated with a set of service components and/or resources used by the software offering may then be calculated by applying the total revenue and the weight vectors to the multidimensional model. For example, the total revenue may correspond to the annual revenue of the software offering, while the weight vectors may be used to split the total revenue into the component revenues that represent the individual contributions of the service components and/or resources to the total revenue.

In particular, the total revenue may be split into the component revenues by setting the total revenue as the component revenue for a root node of the multidimensional model. A set of child component revenues may then be calculated for each set of child nodes below the root node by applying a weight vector associated with the set of child nodes to a parent component revenue for a parent node of the child nodes. For example, a first set of child component revenues for child nodes of the root node may be calculated by applying a weight vector to the total revenue. Additional sets of child component revenues may then be calculated by applying one or more weight vectors to the first set of child component revenues and/or the additional (e.g., newly calculated) sets of child component revenues until component revenues have been calculated for all relevant nodes in the multidimensional model.

The component revenues may then be used to facilitate management of the software offering. First, the component revenues may be used to determine a recovery sequence for the software offering. For example, the recovery sequence may correspond to a decreasing sequence of component revenues to prioritize the restoration of higher-revenue service components and/or resources. The component revenues may also be used to modify use of the service components and the resources by the software offering based on the component revenues. For example, the component revenues may facilitate the allocation of spending on the service components and the resources, the prioritization of service requests associated with the service components and/or resources, and/or the reprovisioning of resources to the software offering. Finally, the component revenues may be used to calculate a cost of an outage associated with the software offering.

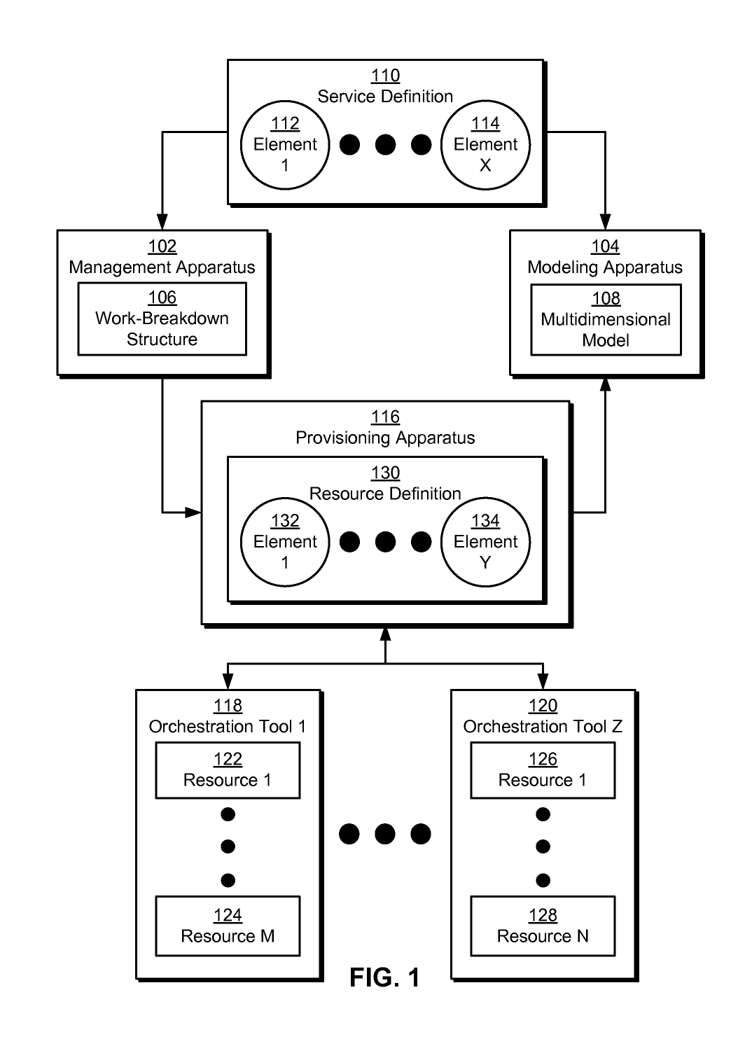

FIG. 1 shows a schematic of a system in accordance with an embodiment. As shown in FIG. 1, the system includes a management apparatus 102, a modeling apparatus 104, and a provisioning apparatus 116. Each of these components is discussed in further detail below.

In one or more embodiments, the system of FIG. 1 is used to manage the deployment and execution of a software offering on a set of resources (e.g., resource 1 122, resource m 124, resource 1 126, resource n 128). The software offering may correspond to a software program that performs tasks for a set of users. For example, the software offering may allow the users to collaborate on projects, file income taxes, manage personal or small business finances, and/or perform data mining on a target data set.

Furthermore, the software offering may be implemented using a client-server architecture. Components of the software offering may be deployed and executed on one or more servers (e.g., in a data center) and accessed from other machines using a locally installed executable, a command-line interface, and/or a web browser and network connection. In other words, the software offering may be implemented using a cloud computing system that is accessed over the Internet.

To enable execution of the software offering, users associated with the creation, deployment, and/or execution of the software offering may determine a set of requirements associated with the software offering. The users may then allocate resources (e.g., resource 1 122, resource m 124, resource 1 126, resource n 128) in the cloud computing system to components in the software offering and configure the allocated resources in a way that allows the executing software offering to meet the requirements. For example, a development team for the software offering may provide a policy specifying a level of availability, reliability, scalability, security, and/or response time in the software offering. Administrators for the cloud computing system may ensure compliance with the policy by allocating sufficient infrastructure resources to the software offering and/or configuring the resources to provide requisite levels of redundancy, security, and/or load balancing in the software offering.

Those skilled in the art will appreciate that the cloud computing system may use virtualization to deploy and execute the software offering on a set of shared resources. In particular, a number of orchestration tools (e.g., orchestration tool 1 118, orchestration tool z 120) may be used to virtualize and/or provision different types of resources in the cloud computing system. For example, a virtual machine monitor may allocate and/or manage computing resources by creating and executing virtual machines as abstractions of physical servers. Similarly, a virtual filer may combine storage resources from a variety of storage devices into a resource pool and allocate logical volumes of storage from the resource pool. Finally, network routers and/or switches may partition network resources into virtual local area networks (VLANs) that connect physical and/or virtual computing and/or storage resources in the cloud computing system.

Moreover, each orchestration tool may include functionality to dynamically reprovision resources in response to changes in the software offering and/or in demand for the resources. For example, a virtual machine monitor may instantiate a new virtual machine to enable the addition of a new web server to the software offering. The virtual machine monitor may also allocate a set of physical computing resources (e.g., processor, memory, etc.) to the virtual machine to enable execution of the web server on the resources. Finally, the virtual machine monitor may move the virtual machine to a different set of physical resources if the web server's resource requirements change and/or the physical resources (e.g., servers) used to execute the web server become overloaded.

In other words, the use of resources by the software offering may be managed by a number of disparate, independently acting orchestration tools. As a result, the cloud computing system may lack a comprehensive view of dependencies between software components in the software offering and the hardware resources used to execute the software components. For example, the cloud computing system may lose track of resources allocated to the software offering once the orchestration tools begin reallocating and/or reprovisioning the resources.

Such lack of dependency information may cause problems with tracking and managing events and/or failures in the cloud computing system. For example, a server outage in the cloud computing system may require manual intervention by administrators to determine the set of hardware and software components affected by the outage and/or perform corrective actions that enable recovery from the server outage.

In one or more embodiments, the system of FIG. 1 reduces complexity associated with managing requirements and dependencies in the software offering by creating a multidimensional model 108 of the software offering and using multidimensional model 108 to manage the deployment and execution of the software offering. As shown in FIG. 1, multidimensional model 108 may be created from a service definition 110 of the software offering and a resource definition 130 of resources available for use by the software offering.

Service definition 110 may be obtained from a user (e.g., developer, architect, etc.) associated with the creation and/or development of the software offering. More specifically, service definition 110 may correspond to a logical representation of the software offering in terms of the software offering's configuration, topology, policies, and/or QoS attributes. As a result, elements (e.g., element 1 112, element x 114) of service definition 110 may include one or more tiers, a set of service components, and/or a set of connections. For example, an architect of the software offering may provide service definition 110 by inputting the number of tiers, level of security, software-development-lifecycle stage, and/or software stack associated with the software offering into a user interface provided by management apparatus 102.

On the other hand, resource definition 130 may be obtained from administrators and/or orchestration tools of the cloud computing system and correspond to a logical representation and/or division of available infrastructure resources in the cloud computing system in terms of the resources' locations, states, and/or utilization. Elements (e.g., element 1 132, element y 134) of resource definition 130 may thus represent physical and/or virtual resources, resource clusters, security zones, hosting segments, and/or locations in the cloud computing system. For example, an administrator may manually populate resource definition 130 with an inventory of physical and/or virtual resources in the cloud computing system, or provisioning apparatus 116 may receive notifications of changes to resources (e.g., addition of new resources, removal of existing resources) in the cloud computing system from the orchestration tools (e.g., virtual machine monitors, virtual filers) and update resource definition 130 accordingly.

To create multidimensional model 108, modeling apparatus 104 may map a first set of elements (e.g., element 1 112, element x 114) from service definition 110 to a second set of elements (e.g., element 1 132, element y 134) from resource definition 130. The mappings may represent dependencies of the first set of elements on the second set of elements. For example, a mapping from a service component in service definition 110 to a resource in resource definition 130 may indicate the allocation of the resource to the service component by an orchestration tool. Creation of multidimensional models for software offerings is discussed in a co-pending non-provisional application by inventors Jerome Labat, Ramachandran Varadharajan, Wilson W. Lau, and Thomas C. Bishop, entitled “Multidimensional Modeling of Software Offerings,” having Ser. No. 13/031,950, and filed on 22 Feb. 2011 (Attorney Docket No. INTU-115591), which is incorporated herein by reference.

In one or more embodiments, the creation of multidimensional model 108 involves the identification of a set of requirements associated with the software offering from service definition 110, as well as the subsequent allocation of a subset of the resources from resource definition 130 to service components in service definition 110 based on the requirements. In particular, management apparatus 102 may determine the software offering's requirements from a set of policies in service definition 110 and store the requirements in a work-breakdown structure 106. The policies may include a software-development-lifecycle policy, a security policy, a software-template policy, a QoS policy, and/or a structural policy. The requirements may thus specify the amount and/or configuration of resources required to satisfy the policies.

Next, provisioning apparatus 116 may use work-breakdown structure 106 to automatically provision a set of resources for use by the software offering without requiring manual configuration of the resources by a user (e.g., administrator). For example, provisioning apparatus 116 may use work-breakdown structure 106 to create a set of service containers for hosting the software offering. Provisioning apparatus 116 may then allocate resources to the service containers by requesting the required amounts and/or configurations of resources from the corresponding orchestration tools. Automatic provisioning of resources to software offerings is discussed in a co-pending non-provisional application by inventors Jerome Labat, Ramachandran Varadharajan, Wilson W. Lau, and Thomas C. Bishop, entitled “Automatic Provisioning of Resources to Software Offerings,” having Ser. No. 13/031,968, and filed on 22 Feb. 2011 (Attorney Docket No. INTU-115592), which is incorporated herein by reference.

As mentioned previously, multidimensional model 108 may include dependencies between service components in service definition 110 and resources in resource definition 130. Consequently, modeling apparatus 104 may create multidimensional model 108 by mapping resources allocated by provisioning apparatus 116 to the service components to which the resources were allocated.

Modeling apparatus 104 may also update the mappings based on changes to the provisioned resources. For example, resources provisioned to service components may change as the orchestration tools allocate new resources, deallocate currently allocated resources, and/or use different sets of physical resources to execute virtualized resources (e.g., virtual machines, logical volumes, VLANs, etc.). Such changes may be obtained by provisioning apparatus 116 through querying and/or monitoring of the orchestration tools. The changes may also be used by provisioning apparatus 116 to update resource definition 130. The updates may then be propagated to multidimensional model 108 via modeling apparatus 104.

Because multidimensional model 108 contains an up-to-date representation of service components, resources, and dependencies in the software offering, the system of FIG. 1 may facilitate management of the software offering within the cloud computing system. For example, multidimensional model 108 may facilitate the automatic deployment of the software offering on the allocated resources, identification of resources allocated to the software offering, identification of failures during execution of the software offering, and/or management of changes associated with the software offering or the resources. In other words, the creation and update of multidimensional model 108 may reduce complexity and/or overhead associated with configuration management, fault diagnosis and remediation, deployment, and/or resource provisioning in the software offering.

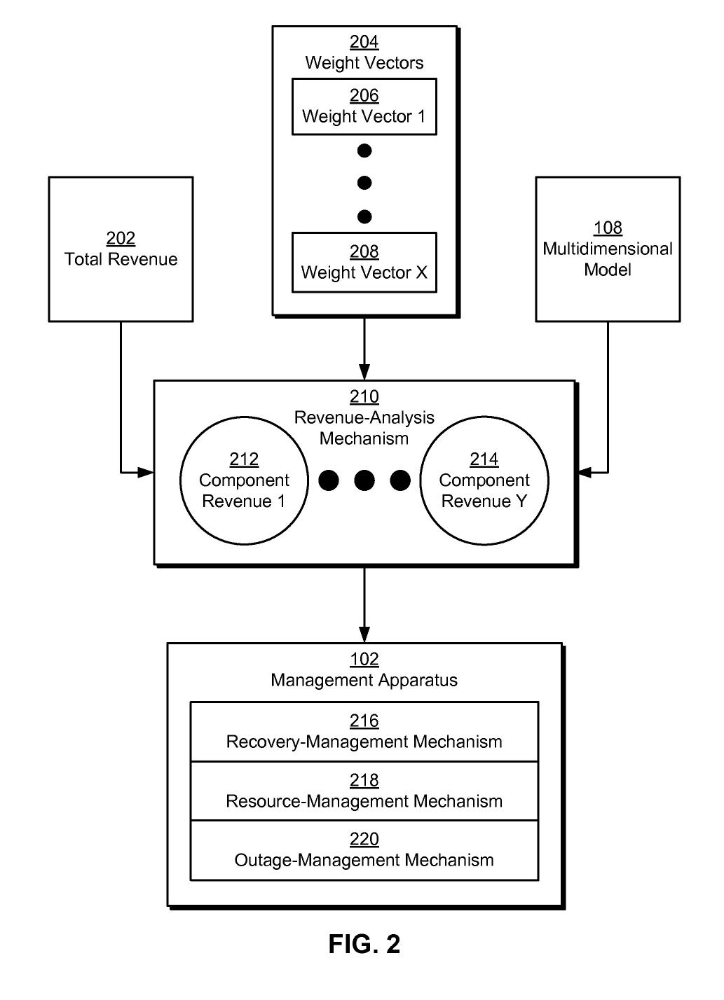

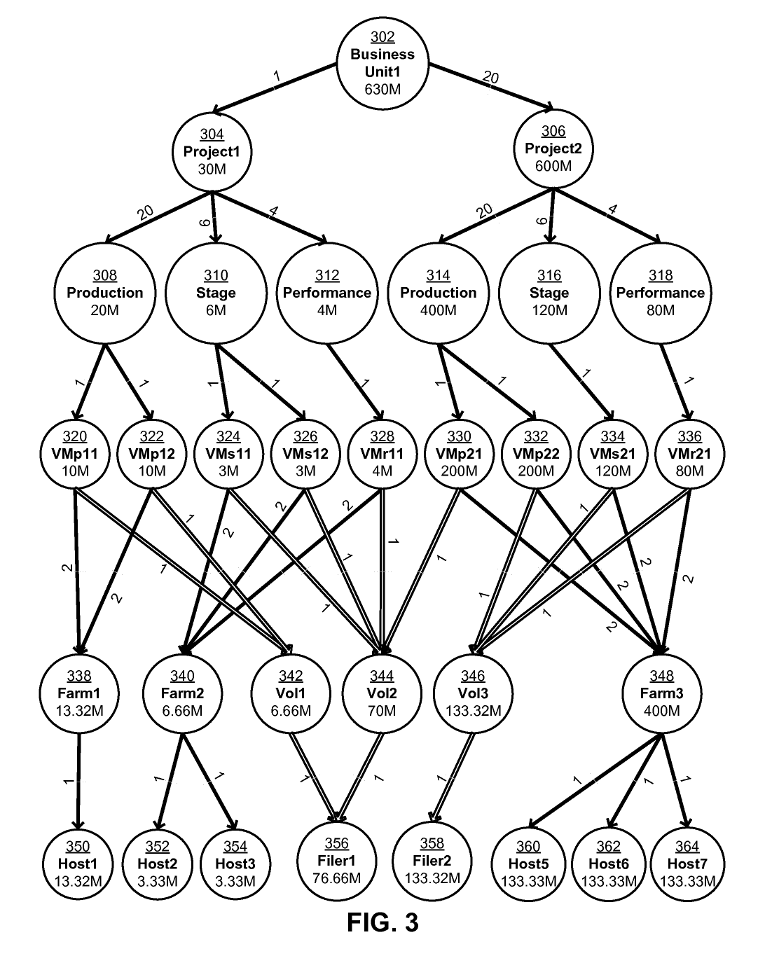

In one or more embodiments, the system of FIG. 1 includes functionality to perform revenue-based impact analysis of the software offering using multidimensional model 108. During the revenue-based impact analysis, a total revenue associated with the software offering and a set of weight vectors associated with multidimensional model 108 may be obtained. Next, a set of component revenues associated with a set of service components and a set of resources used by the software offering may be calculated by applying the total revenue and the weight vectors to the multidimensional model. Calculation of component revenues is discussed in further detail below with respect to FIGS. 2-3.

The component revenues may then be used to facilitate management of the software offering. As discussed below with respect to FIG. 2, the component revenues may be used to determine a recovery sequence for the software offering, modify use of the service components and the resources by the software offering, and/or calculate a cost of an outage associated with the software offering based on the component revenues. Consequently, the disclosed embodiments may increase use of multidimensional model 108 in managing the software offering across the software development lifecycle of the software offering.

FIG. 2 shows a system for performing revenue-based impact analysis of a software offering in accordance with an embodiment. As mentioned above, the revenue-based impact analysis may involve the calculation of a set of component revenues (e.g., component revenue 1 212, component revenue y 214) associated with a set of service components and/or resources used by the software offering.

In particular, a revenue-analysis mechanism 210 may calculate the component revenues based on a total revenue 202 associated with the software offering, a set of weight vectors 204 (e.g., weight vector 1 206, weight vector x 208) associated with multidimensional model 108, and multidimensional model 108. Revenue-analysis mechanism 210 may be provided by management apparatus 102, a modeling apparatus (e.g., modeling apparatus 104 of FIG. 1), and/or another component with access to total revenue 202, weight vectors 204, and/or multidimensional model 108. For example, revenue-analysis mechanism 210 may provide a graphical user interface (GUI) that obtains total revenue 202 and/or weight vectors 204 from a user associated with the software offering, such as an administrator. Alternatively, total revenue 202, weight vectors 204, and/or multidimensional model 108 may be transmitted over a network connection to revenue-analysis mechanism 210 for use in computing the component revenues.

Total revenue 202 may represent the income associated with operation of the software offering. For example, total revenue 202 may correspond to the annual income from licensing of the software offering, subscriptions to the software offering, and/or sales of ads displayed within the software offering. On the other hand, weight vectors 204 may be used to split total revenue 202 into the component revenues. More specifically, each of the weight vectors 204 may include a set of revenue weights that is used to calculate the portions of total revenue 202 and/or a component revenue to which a particular service component and/or resource contributes during execution of the software offering. In other words, the component revenue for a service component and/or resource may represent the amount of revenue contributed by the service component and/or resource to the software offering.

To calculate the component revenues, revenue-analysis mechanism 210 may use total revenue 202 as the component revenue for a root node of multidimensional model 108. For example, revenue-analysis mechanism 210 may obtain total revenue 202 as the annual revenue of the software offering and set the component revenue for a root node representing the software offering to total revenue 202. After the component revenue of the root node is set, revenue-analysis mechanism 210 may recursively calculate a set of child component revenues for each set of child nodes in multidimensional model 108 by applying a weight vector associated with the set of child nodes to a previously calculated parent component revenue for a parent node of the child nodes.

For example, revenue-analysis mechanism 210 may calculate a first set of child component revenues for child nodes of the root node by applying a weight vector that divides total revenue 202 into portions of total revenue 202 contributed by each of the child nodes. Revenue-analysis mechanism 210 may then calculate additional sets of child component revenues for lower nodes in multidimensional model 108 by applying other weight vectors to the first set of child component revenues and/or other previously calculated sets of child component revenues until a component revenue is calculated for every relevant node in multidimensional model 108.

In one or more embodiments, a weight vector includes identical revenue weights if the weight vector is associated with a set of identical service components or resources. On the other hand, a weight vector may contain dissimilar revenue weights if the weight vector is associated with a set of non-identical and/or heterogeneous service components or resources. For example, a weight vector that is used to split a parent component revenue of a virtual server farm among five identical physical hosts may contain five revenue weights of the same value. Conversely, a weight vector that is used to split a parent component revenue of a virtual machine among a storage volume and a virtual server farm may include two different revenue weights representing unequal contributions to the parent component revenue by the storage volume and the virtual server farm.

Moreover, calculation of the component revenues may involve the splitting of a parent component revenue into a set of child component revenues and/or the merging of a set of parent component revenues from two or more parent nodes into a child component revenue for a child node connected to the parent nodes. As discussed in the above example, a parent component revenue of a virtual machine may be split between a storage volume and a virtual server farm. However, multiple virtual machines may also share the same storage volume and/or virtual server farm. Consequently, the component revenue of a storage volume and/or virtual server farm may be calculated as a sum of the portions of the virtual machines' component revenues to which the storage volume and/or virtual server farm contribute. Calculation of component revenues is discussed in further detail below with respect to FIG. 3.

Once the component revenues are calculated, the component revenues may be used by management apparatus 102 to facilitate management of the software offering. First, a recovery-management mechanism 216 in management apparatus 102 may use the component revenues to determine a recovery sequence for the software offering. The recovery sequence may specify the order of recovery of service components and/or resources in the event of an outage and/or disaster. In addition, the recovery sequence may correspond to a decreasing sequence of component revenues to prioritize the restoration of higher-revenue service components and/or resources, and in turn, mitigate revenue losses during the outage and/or disaster. For example, the recovery sequence may specify the restoration of physical hosts and/or storage volumes associated with a higher-revenue software offering prior to the restoration of physical hosts and/or storage volumes associated with a lower-revenue software offering.

Next, a resource-management mechanism 218 in management apparatus 102 may modify the software offering's use of service components and/or resources based on the component revenues. Such modification may occur during the allocation of spending on the service components and/or resources, the prioritization of service requests associated with the service components and/or resources, and/or during the reprovisioning of resources to the software offering.

For example, resource-management mechanism 218 may calculate a ratio of component revenue to component cost for each service component and/or resource used by the software offering. Afterwards, resource-management mechanism 218 may use the calculated ratios to suggest the increased allocation of funds for upgrading service components and/or resources with higher ratios of component revenue to component cost and the reduction of funds used in upgrading service components and/or resources with lower ratios of component revenue to component cost. Resource-management mechanism 218 may also prioritize service requests associated with the software offering so that service requests for higher-revenue service components and/or resources are fulfilled more quickly than service requests for lower-revenue service components and/or resources. Finally, resource-management mechanism 218 may specify the reprovisioning (e.g., scaling up, clustering, etc.) of some resources used by service components associated with lower component revenues to service components associated with higher component revenues.

Finally, an outage-management mechanism 220 in management apparatus 102 may calculate a cost of an outage associated with the software offering. To calculate the cost of an outage, outage-management mechanism 220 may obtain an outage period for the outage, determine a fraction of total transactions for the software offering represented by a number of missed transactions associated with the outage, and multiply one or more of the component revenues associated with the outage by the fraction of total transactions.

For example, outage-management mechanism 220 may use an outage period of eight hours during peak usage of the software offering and a set of yearly transaction trends for the software offering to determine the number of missed transactions during the outage (e.g., 20 per user) and the total number of transactions over a year (e.g., 1000 per user). Outage-management mechanism 220 may then divide the number of missed transactions by the number of total transactions and multiply the resulting fraction (e.g., 1/50) by the annual revenue of a virtual machine affected by the outage (e.g., $10 million) to obtain a cost of $200,000 for the outage.

Outage-management mechanism 220 may thus facilitate decisions regarding maintenance of the software offering and/or requirements associated with the availability and/or capacity of the software offering. For example, outage-management mechanism 220 may calculate a set of outage costs associated with actual and/or hypothetical outages in the software offering and use the outage costs to determine the amount of availability and/or capacity required in the software offering to avert the costliest outages.

FIG. 3 shows an exemplary set of component revenues for a set of nodes 302-364 in a multidimensional model (e.g., multidimensional model 108 of FIG. 1) in accordance with an embodiment. As discussed above, the component revenues may be calculated by setting the component revenue of a root node 302 to a total revenue associated with the multidimensional model. For example, the component revenue of root node 302 (e.g., “630M”) may correspond to the annual revenue of a business unit named “Business Unit1.”

Next, a set of child component revenues for child nodes 304-306 (e.g., “Project1,” “Project2”) of root node 302 may be calculated by splitting the parent component revenue of root node 302 into two portions. As shown in FIG. 3, a weight vector containing revenue weights of “1” and “20” may split the parent component revenue of “630M” into a child component revenue of “30M” for node 304 and a child component revenue of “600M” for node 306. In other words, the project represented by node 304 may contribute one “share” of the total revenue for the business unit, while the project represented by node 306 may contribute 20 “shares” of the total revenue. The significant difference in revenue between the two projects may cause the project named “Project2” to be prioritized over the project named “Project1” during disaster recovery, resource provisioning, and/or allocation of spending within the business unit.

After component revenues of nodes 304-306 are calculated, child component revenues may be calculated for child nodes 308-312 (e.g., “Production,” “Stage,” “Performance”) of node 304 and child nodes 314-318 (e.g., “Production,” “Stage,” “Performance”) of node 306. Child nodes 308-318 may represent production, stage, and/or performance execution environments for the two projects, with production environments associated with more value than the other two types of execution environments. Consequently, 20 “shares” of the parent component revenue for each node 304-306 may be contributed by the production environments represented by nodes 308 and 314, six “shares” may be contributed by the stage environments represented by nodes 310 and 316, and four “shares” may be contributed by the performance environments represented by nodes 312 and 318. The “30M” parent component revenue for node 304 may thus produce child component revenues of “20M,” “6M,” and “4M” for nodes 308-312, respectively. Similarly, the “600M” parent component revenue for node 306 may be split into child component revenues of “400M,” “120M,” and “80M” for nodes 314-318, respectively.

Nodes 308-318 may then be connected to a set of nine nodes 320-336. In particular, node 308 is a parent of nodes 320-322 (e.g., “VMp11,” “VMp12”), node 310 is a parent of nodes 324-326 (e.g., “VMs11,” “VMs12”), and node 312 is a parent of node 328 (e.g., “VMr11”). Node 314 is a parent of nodes 330-332 (e.g., “VMp21,” “VMp22”), node 316 is a parent of node 334 (e.g., “VMs21”), and node 318 is a parent node of node 336 (e.g., “VMr21”). Nodes 320-336 may thus represent the use of virtual machines in the production, stage, and performance environments of the two projects.

Because the virtual machines for a given environment may be identical (e.g., contain the same types and amounts of resources), weight vectors for splitting parent component revenues for nodes 308-318 among nodes 320-336 may contain identical revenue weights. As a result, the “20M” parent component revenue for node 308 may be split equally into two “10M” child component revenues for nodes 320-322, and the “6M” parent component revenue for node 310 may be split equally into two “3M” child component revenues for nodes 324-326. Similarly, the “400M” parent component revenue for node 314 may be split equally into two “200M” child component revenues for nodes 330-332. In addition, the parent component revenues (e.g., “4M,” “120M,” “80M”) of nodes 312, 316, and 318 may be copied directly to the child component revenues of nodes 328, 334, and 336 because nodes 328, 334, and 336 are the only child nodes of nodes 312, 316, and 318, respectively.

Continuing with the multidimensional model, nodes 320-322 are connected to nodes 338 (e.g., “Farm1”) and 342 (e.g., “Vo11”), nodes 324-328 are connected to nodes 340 (e.g., “Farm2”) and 344 (e.g., “Vo12”), node 330 is connected to nodes 344 and 348 (e.g., “Farm3”), and nodes 332-336 are connected to nodes 346 (e.g., “Vo13”) and 348. Nodes 338-348 may thus represent virtual server farms and/or storage volumes on which the virtual machines represented by nodes 320-336 execute. Furthermore, connection of each node 320-336 to two child nodes 338-348 representing different types of resources may result in an uneven distribution of revenue between the two child nodes. For example, weight vectors associated with the distribution of parent component revenues for nodes 320-336 among nodes 338-348 may assign two “shares” of each parent component revenue to the child node representing a virtual server farm and one “share” of the parent component revenue to the child node representing the storage volume.

At the same time, the sharing of nodes 338-348 as child nodes of multiple nodes 320-336 may cause parent component revenues from two or more nodes 320-336 to be merged into a child component revenue for a child node 338-348 connected to the parent nodes. More specifically, the “13.32M” child component revenue for node 338 may be obtained by merging ⅔ of the parent component revenues for nodes 320-322, and the “6.66M” child component revenue for node 340 may be calculated by merging ⅔ of the parent component revenues of nodes 324-328. Next, the “6.66M” child component revenue for node 342 may be calculated by summing 1/3 of the parent component revenues for nodes 320-322, and the “70M” child component revenue for node 344 may be obtained by adding up ⅓ of the parent component revenues for nodes 324-330. The “133.32M” child component revenue for node 346 may represent the merging of ⅓ of the parent component revenues for nodes 332-336, and the “400M” child component revenue for node 348 may be calculated by merging ⅔ of the parent component revenues for nodes 330-336.

The final child component revenues in the multidimensional model may be obtained by splitting the parent component revenues for nodes 338-348 among nodes 350-364. Node 350 (e.g., “Host1”) is the only child of node 338 and thus has the same “13.32M” component revenue as node 338. Nodes 352-354 (e.g., “Host2,” “Host3”) may split the “6.66M” parent component revenue of node 340 into equal child component revenues of “3.33M.” Node 356 (e.g., “Filed”) is the only child of both nodes 342-344 and thus has a “76.66M” child component revenue that is the sum of the “6.66M” and “70M” parent component revenues of nodes 342-344. As the only child of node 346, node 358 (e.g., “Filer2”) has a “133.32M” child component revenue that is the same as the parent component revenue of node 346. Finally, nodes 360-364 (e.g., “Host5,” “Host6,” “Host?”) split the “400M” parent component revenue of node 348 into three equal shares of “133.33M.”

Nodes 350-364 may thus represent the use of physical hosts represented by nodes 350-354 and 360-364 in virtual server farms represented by nodes 338-340 and 348 and the use of storage volumes represented by nodes 342-346 by virtual filers represented by nodes 356-358. In addition, the component revenues of nodes 350-364 may be used to determine a recovery sequence for the resources represented by nodes 350-364 and/or modify use of resources by nodes 350-364. For example, the higher component values for nodes 360-364 may be used to prioritize the recovery of physical hosts represented by nodes 360-364 over the recovery of physical hosts represented by nodes 350-354 in the event of a disaster and/or outage. Similarly, differences in component value between nodes 356-358 may cause storage resources to be deallocated from the virtual filer represented by node 356 and reallocated to the virtual filer represented by node 358.

Those skilled in the art will appreciate that component revenues may also be calculated for a variety of other nodes in the multidimensional model. For example, component revenues may be calculated for network resources (e.g., virtual networks, routers, switches, network interface cards (NICs)), security zones, web servers, application servers, databases, and/or other service components and/or resources used by the software offering. Conversely, component revenues may only be calculated for nodes that are relevant to revenue-based analysis of the software offering. For example, finer-grained impact analysis of the software offering may be conducted by calculating component revenues for hardware components (e.g., processors, memory, etc.) within physical resources from the component revenues for nodes 350-364. On the other hand, component revenues may not be calculated for some types of resources and/or service components if the resources and/or service components are not being considered in terms of disaster recovery, spending and/or resource allocation, and/or outage cost calculation.

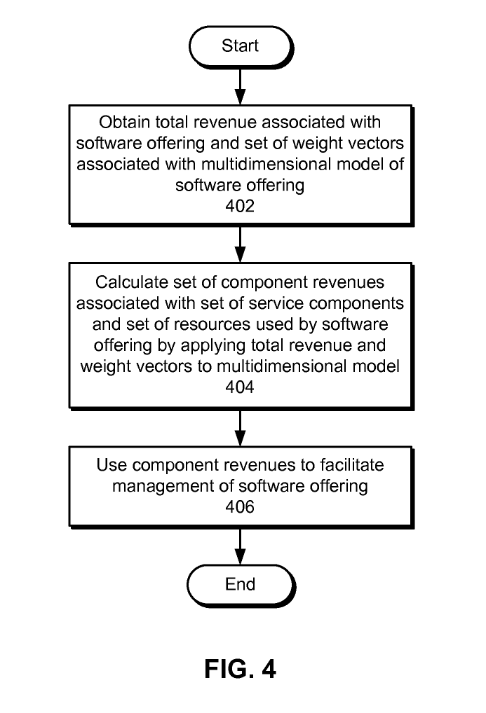

FIG. 4 shows a flowchart illustrating the process of facilitating the maintenance and execution of a software offering in accordance with an embodiment. In one or more embodiments, one or more of the steps may be omitted, repeated, and/or performed in a different order. Accordingly, the specific arrangement of steps shown in FIG. 4 should not be construed as limiting the scope of the technique.

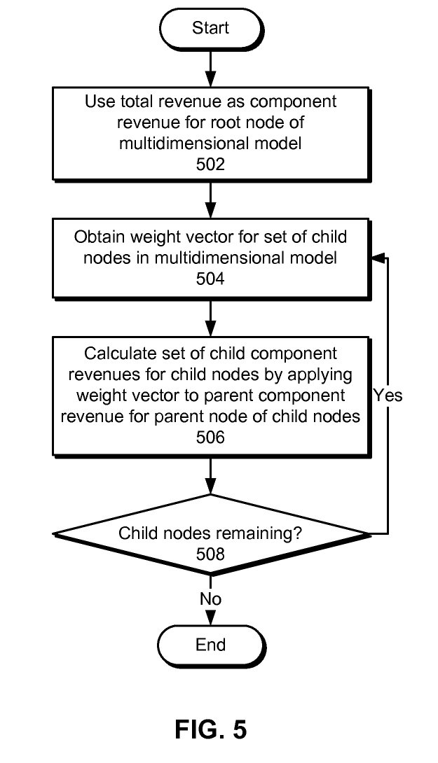

Initially, a total revenue associated with the software offering and a set of weight vectors associated with a multidimensional model of the software offering are obtained (operation 402). Each of the weight vectors may include a set of revenue weights. Next, a set of component revenues associated with a set of service components and a set of resources used by the software offering is calculated by applying the total revenue and weight vectors to the multidimensional model (operation 404). Calculation of component revenues is discussed in further detail below with respect to FIG. 5.

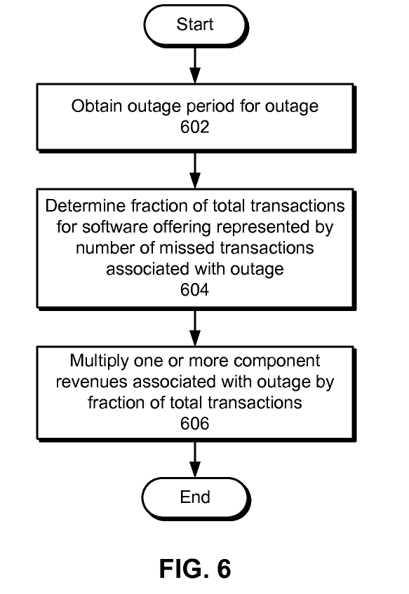

Finally, the component revenues are used to facilitate management of the software offering (operation 406). For example, the component revenues may be used to determine a recovery sequence for the software offering, modify use of the service components and the resources by the software offering, and/or calculate a cost of an outage associated with the software offering based on the component revenues. Calculation of the cost of an outage associated with a software offering is discussed in further detail with respect to FIG. 6.

FIG. 5 shows a flowchart illustrating the process of calculating a set of component revenues associated with service components and resources used by a software offering in accordance with an embodiment. In one or more embodiments, one or more of the steps may be omitted, repeated, and/or performed in a different order. Accordingly, the specific arrangement of steps shown in FIG. 5 should not be construed as limiting the scope of the technique.

First, a total revenue associated with the software offering is used as a component revenue for a root node of the multidimensional model (operation 502). Next, a weight vector is obtained for a set of child nodes in the multidimensional model (operation 504), and a set of child component revenues is calculated for a set of child nodes by applying the weight vector to the parent component revenue for a parent node of the child nodes (operation 506). For example, a first set of child component revenues for child nodes of the root node may be calculated by applying a weight vector to the total revenue.

Operations 504-506 may be repeated for remaining child nodes (operation 508) in the multidimensional model. For each set of child nodes connected to a node with a newly computed component revenue, a weight vector is obtained (operation 504), and a set of child component revenues is calculated for the child nodes by applying the weight vector to the parent component revenue for the parent node of the child nodes (operation 506). In addition, the child component revenues may be calculated by splitting the parent component revenue into the set of child component revenues and/or by merging a set of parent component revenues from two or more parent nodes into a child component revenue for a child node connected to the parent nodes. Operations 504-506 may thus continue until component revenues have been calculated for all relevant nodes in the multidimensional model.

FIG. 6 shows a flowchart illustrating the process of calculating the cost of an outage associated with a software offering in accordance with an embodiment. In one or more embodiments, one or more of the steps may be omitted, repeated, and/or performed in a different order. Accordingly, the specific arrangement of steps shown in FIG. 6 should not be construed as limiting the scope of the technique.

First, an outage period for the outage is obtained (operation 602). For example, the outage period may correspond to a range of time specified using two timestamps, one representing the beginning of the outage and one representing the end of the outage. Next, a fraction of total transactions for the software offering represented by a number of missed transactions associated with the outage may be determined (operation 604). For example, a set of transaction trends for the software offering may be used to determine both the number of missed transactions during the outage and the number of total transactions for a given period (e.g., day, month, season, year) containing the outage. The fraction of total transactions may then be obtained by dividing the number of missed transactions by the number of total transactions.

Finally, one or more component revenues associated with the outage are multiplied by the fraction of total transactions (operation 606). For example, the cost of an outage affecting a virtual machine may be obtained by multiplying the annual (e.g., component) revenue associated with the virtual machine by the fraction of annual transactions represented by the number of missed transactions in the virtual machine during the outage.

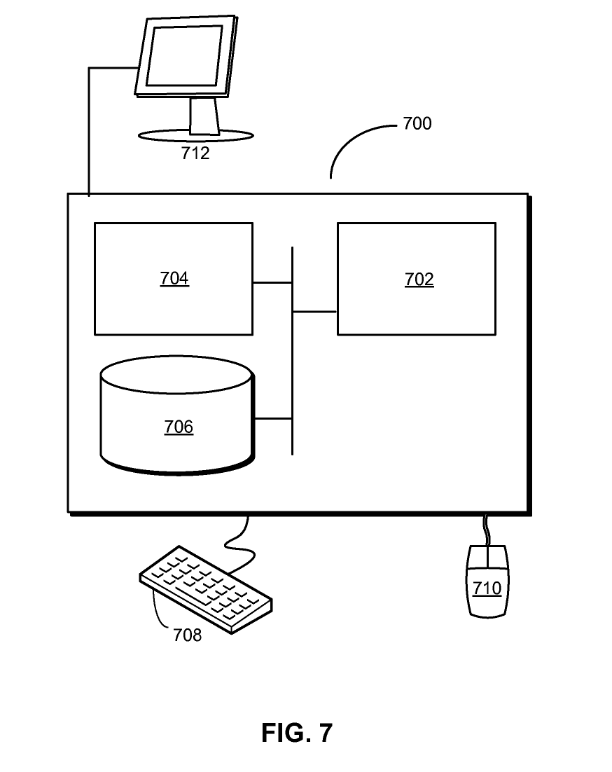

FIG. 7 shows a computer system 700 in accordance with an embodiment. Computer system 700 may correspond to an apparatus that includes a processor 702, memory 704, storage 706, and/or other components found in electronic computing devices. Processor 702 may support parallel processing and/or multi-threaded operation with other processors in computer system 700. Computer system 700 may also include input/output (I/O) devices such as a keyboard 708, a mouse 710, and a display 712.

Computer system 700 may include functionality to execute various components of the present embodiments. In particular, computer system 700 may include an operating system (not shown) that coordinates the use of hardware and software resources on computer system 700, as well as one or more applications that perform specialized tasks for the user. To perform tasks for the user, applications may obtain the use of hardware resources on computer system 700 from the operating system, as well as interact with the user through a hardware and/or software framework provided by the operating system.

In one or more embodiments, computer system 700 provides a system for facilitating the maintenance and execution of a software offering. The system may include a revenue-analysis mechanism that obtains a total revenue associated with the software offering and a set of weight vectors associated with a multidimensional model of the software offering. The revenue-analysis mechanism may also calculate a set of component revenues associated with a set of service components and a set of resources used by the software offering by applying the total revenue and the weight vectors to the multidimensional model. The system may additionally include a management apparatus that uses the component revenues to facilitate management of the software offering.

In addition, one or more components of computer system 700 may be remotely located and connected to the other components over a network. Portions of the present embodiments (e.g., revenue-analysis mechanism, management apparatus, etc.) may also be located on different nodes of a distributed system that implements the embodiments. For example, the present embodiments may be implemented using a cloud computing system that manages the deployment, execution, and maintenance of a software offering.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A computer-implemented method for facilitating the maintenance and execution of a software offering, comprising:
obtaining a total revenue associated with the software offering and a set of weight vectors associated with a multidimensional model of the software offering, wherein each of the weight vectors comprises a set of revenue weights;
calculating a set of component revenues associated with a set of service components and a set of resources used by the software offering by applying the total revenue and the weight vectors to the multidimensional model; and
using the component revenues to facilitate management of the software offering.

2. The computer-implemented method of claim 1, wherein calculating the set of component revenues associated with the service components and the resources used by the software offering involves:
using the total revenue as a component revenue for a root node of the multidimensional model; and
calculating a set of child component revenues for each set of child nodes in the multidimensional model by applying a weight vector associated with the set of child nodes to a parent component revenue for a parent node of the child nodes.

3. The computer-implemented method of claim 2, wherein calculating the set of child component revenues involves at least one of:
splitting the parent component revenue into the set of child component revenues; and
merging a set of parent component revenues from two or more parent nodes into a child component revenue for a child node connected to the parent nodes.

4. The computer-implemented method of claim 1,
wherein a weight vector comprises identical revenue weights if the weight vector is associated with a set of identical service components or resources, and
wherein a weight vector comprises dissimilar revenue weights if the weight vector is associated with a set of non-identical service components or resources.

5. The computer-implemented method of claim 1, wherein using the component revenues to facilitate management of the software offering involves at least one of:
using the component revenues to determine a recovery sequence for the software offering;
modifying use of the service components and the resources by the software offering based on the component revenues; and
calculating a cost of an outage associated with the software offering based on the component revenues.

6. The computer-implemented method of claim 5, wherein the recovery sequence corresponds to a decreasing sequence of the component revenues.

7. The computer-implemented method of claim 5, wherein modifying use of the service components and the resources by the software offering based on the component revenues involves at least one of:
allocating spending on the service components and the resources based on the component revenues;
prioritizing service requests associated with the service components and the resources; and
reprovisioning resources to the software offering based on the component revenues.

8. The computer-implemented method of claim 5, wherein calculating the cost of the outage associated with the software offering based on the component revenues involves:
obtaining an outage period for the outage;
determining a fraction of total transactions for the software offering represented by a number of missed transactions associated with the outage; and
multiplying one or more of the component revenues associated with the outage by the fraction of total transactions.

9. A system for facilitating the maintenance and execution of a software offering, comprising:
a revenue-analysis mechanism configured to:
obtain a total revenue associated with the software offering and a set of weight vectors associated with a multidimensional model of the software offering, wherein each of the weight vectors comprises a set of revenue weights; and
calculate a set of component revenues associated with a set of service components and a set of resources used by the software offering by applying the total revenue and the weight vectors to the multidimensional model; and
a management apparatus configured to use the component revenues to facilitate management of the software offering

10. The system of claim 9, wherein calculating the set of component revenues associated with the service components and the resources used by the software offering involves:
using the total revenue as a component revenue for a root node of the multidimensional model; and
calculating a set of child component revenues for each set of child nodes in the multidimensional model by applying a weight vector associated with the set of child nodes to a parent component revenue for a parent node of the child nodes.

11. The system of claim 10, wherein calculating the set of child component revenues involves at least one of:
splitting the parent component revenue into the set of child component revenues; and
merging a set of parent component revenues from two or more parent nodes into a child component revenue for a child node connected to the parent nodes.

12. The system of claim 9,
wherein a weight vector comprises identical revenue weights if the weight vector is associated with a set of identical service components or resources, and
wherein a weight vector comprises dissimilar revenue weights if the weight vector is associated with a set of non-identical service components or resources.

13. The system of claim 9, wherein using the component revenues to facilitate management of the software offering involves at least one of:
using the component revenues to determine a recovery sequence for the software offering;
modifying use of the service components and the resources by the software offering based on the component revenues; and
calculating a cost of an outage associated with the software offering based on the component revenues.

14. The system of claim 13, wherein the recovery sequence corresponds to a decreasing sequence of the component revenues.

15. The system of claim 13, wherein modifying use of the service components and the resources by the software offering based on the component revenues involves at least one of:
allocating spending on the service components and the resources based on the component revenues;
prioritizing service requests associated with the service components and the resources; and
reprovisioning resources to the software offering based on the component revenues.

16. The system of claim 13, wherein calculating the cost of the outage associated with the software offering based on the component revenues involves:
obtaining an outage period for the outage;
determining a fraction of total transactions for the software offering represented by a number of missed transactions associated with the outage; and
multiplying one or more of the component revenues associated with the outage by the fraction of total transactions.

17. A computer-readable storage medium storing instructions that when executed by a computer cause the computer to perform a method for facilitating the maintenance and execution of a software offering, the method comprising:
obtaining a total revenue associated with the software offering and a set of weight vectors associated with a multidimensional model of the software offering, wherein each of the weight vectors comprises a set of revenue weights;
calculating a set of component revenues associated with a set of service components and a set of resources used by the software offering by applying the total revenue and the weight vectors to the multidimensional model; and
using the component revenues to facilitate management of the software offering.

18. The computer-readable storage medium of claim 17, wherein calculating the set of component revenues associated with the service components and the resources used by the software offering involves:
using the total revenue as a component revenue for a root node of the multidimensional model; and
calculating a set of child component revenues for each set of child nodes in the multidimensional model by applying a weight vector associated with the set of child nodes to a parent component revenue for a parent node of the child nodes.

19. The computer-readable storage medium of claim 18, wherein calculating the set of child component revenues involves at least one of:
splitting the parent component revenue into the set of child component revenues; and
merging a set of parent component revenues from two or more parent nodes into a child component revenue for a child node connected to the parent nodes.

20. The computer-readable storage medium of claim 17,
wherein a weight vector comprises identical revenue weights if the weight vector is associated with a set of identical service components or resources, and
wherein a weight vector comprises dissimilar revenue weights if the weight vector is associated with a set of non-identical service components or resources.

21. The computer-readable storage medium of claim 17, wherein using the component revenues to facilitate management of the software offering involves at least one of:
using the component revenues to determine a recovery sequence for the software offering;
modifying use of the service components and the resources by the software offering based on the component revenues; and
calculating a cost of an outage associated with the software offering based on the component revenues.

22. The computer-readable storage medium of claim 21, wherein the recovery sequence corresponds to a decreasing sequence of the component revenues.

23. The computer-readable storage medium of claim 21, wherein modifying use of the service components and the resources by the software offering based on the component revenues involves at least one of:
allocating spending on the service components and the resources based on the component revenues;
prioritizing service requests associated with the service components and the resources; and
reprovisioning resources to the software offering based on the component revenues.

24. The computer-readable storage medium of claim 21, wherein calculating the cost of the outage associated with the software offering based on the component revenues involves:
obtaining an outage period for the outage;
determining a fraction of total transactions for the software offering represented by a number of missed transactions associated with the outage; and
multiplying one or more of the component revenues associated with the outage by the fraction of total transactions.
